(19) United States
(12) Patent Application Publication
(10) Pub. No.: US 2015/0151744 A1
(43) Pub. Date: Jun. 4, 2015

(54) VEHICLE BODY VIBRATION CONTROL DEVICE FOR VEHICLE

(71) Applicant: TOYOTA JIDOSHA KABUSHIKI KAISHA, Toyota-shi (JP)

(72) Inventors: Shotaro SASAKI, Susono-shi (JP); Mitsuhiko MORITA, Sunto-gun (JP); Hirofumi MOMOSE, Numazu-shi (JP); Takashi SAITO, Fuji-shi (JP)

(73) Assignee: TOYOTA JIDOSHA KABUSHIKI KAISHA, Toyota-shi (JP)

(21) Appl. No.: 14/554,516

(22) Filed: Nov. 26, 2014

(30) Foreign Application Priority Data
Nov. 29, 2013 (JP) 2013-248605

(51) Int. Cl. B60W 30/02; B60L 11/18; B60W 50/06

(52) U.S. Cl. CPC B60W 30/025; B60W 50/06; B60L 11/18

(57) ABSTRACT

Provided is a vehicle body vibration control device (10) for a vehicle, including a request driving force calculation unit (20) calculating driver's request driving force, a driving unit (16) including an electric motor (EM) and applying driving force to a vehicle (12), a driving force control unit (22) controlling the driving unit based on a command driving force, and a notch filter (24) receiving a signal indicating the request driving force, processing the signal so as to reduce a frequency component of vibration of a vehicle body, and outputting the processed signal to the driving force control unit as a signal indicating the command driving force. The vehicle body vibration control device (10) further includes a notch filter control unit (26) variably setting a notch degree of the notch filter based on a shift position or a traveling mode unique to the vehicle including the electric motor.

### BACKGROUND OF THE INVENTION

1. Field of the Invention

The present invention relates to a vehicle body vibration control device for a vehicle such as an automobile, and more particularly, to a vehicle body vibration control device configured to suppress vibration of a vehicle body, which is caused by fluctuation in driving force of the vehicle.

2. Description of the Related Art

Vehicles such as automobiles travel by a driving force generated by a driving unit including a driving source such as an engine or an electric motor or electric motors. Fluctuation in driving force generated from the driving unit causes loads to be applied on the vehicle body in a fore-and-aft direction and a vertical direction of the vehicle relative to wheels. Thus, pitching vibration occurs in the vehicle body. Therefore, it has been suggested that the pitching vibration of the vehicle body be reduced through appropriate control of a command driving force to the driving unit.

For example, Japanese Patent Application Laid-open No. 2007-237879 filed by the applicant of this application describes a vehicle body vibration control device configured based on the above-mentioned concept. This vehicle body vibration control device includes a request driving force calculation unit configured to calculate a driver's request driving force, a driving unit configured to apply a driving force to a vehicle, a driving force control unit configured to control the driving unit based on a command driving force, and a notch filter configured to receive a signal indicating the request driving force from the request driving force calculation unit. The notch filter has a notch frequency set to a value for reducing a frequency component of vibration of a vehicle body. The notch filter subjects the signal to filter processing, and outputs the processed signal to the driving force control unit as a signal indicating the command driving force.

According to the vehicle body vibration control device of this type, the signal indicating the driver's request driving force is processed by the notch filter, and the driving unit is controlled based on the command driving force reduced in frequency component of the vibration of the vehicle body. As a result, the pitching vibration of the vehicle body can be reduced.

When the signal indicating the request driving force is processed by the notch filter to reduce the vibration of the vehicle body, the driver's request driving force is smoothed through the filter processing to generate the command driving force. Consequently, responsiveness of the driving force of the vehicle to the request driving force is reduced. For example, during acceleration, in other words, during increase of the request driving force, the command driving force is controlled to a smaller side compared to the request driving force. Conversely, during deceleration, in other words, during decrease of the request driving force, the command driving force is controlled to a larger side compared to the request driving force.

Thus, in the case of the vehicle including the engine as the driving source, a notch degree of the notch filter is set to be variable in accordance with an engine speed or the like, and thus uncomfortable feeling caused by a delayed response of the driving force is reduced while suppressing vehicle body vibration as effectively as possible.

The reduction of the responsiveness of the driving force of the vehicle to the request driving force through the filter processing does not occur only in the vehicle including the engine as the driving source. Such reduction similarly occurs in a hybrid vehicle, an electric vehicle, and a fuel-cell vehicle including electric motors as driving sources.

However, the vehicle including an electric motor as the driving source has characteristics different from those of the vehicle including the engine as the driving source. For example, the vehicle including the electric motor as the driving source has a characteristic shift position referred to as a brake (B) range, which is a deceleration driving force transmission position for generating, for example, a deceleration action by the electric motor. The deceleration action by the electric motor is idiomatically referred to as an “engine brake”, and thus hereinafter referred to as the “engine brake” when necessary.

The vehicle including the electric motor as the driving source has a characteristic traveling mode referred to as an eco-traveling mode for setting a response of the driving force to be a response lower than a standard response by using the electric motor. In particular, the hybrid vehicle has a characteristic traveling mode referred to as an electric vehicle mode for driving the vehicle only by the driving force of the electric motor without using any driving force of the engine.

Each of the characteristic shift position and traveling mode of the vehicle including the electric motor as the driving source has optimal responsiveness of the driving force of the vehicle to a driving operation. Accordingly, the variable setting of the notch degree, which is carried out in the vehicle including the engine as the driving source, cannot be directly applied to the vehicle including the electric motor as the driving source. Responsiveness optimal to each of the shift position and the traveling mode cannot be set by the variable setting of the notch degree, which is carried out in the vehicle including the engine as the driving source.

### SUMMARY OF THE INVENTION

It is a main object of the present invention to set responsiveness of a driving force of the vehicle, which includes an electric motor as the driving source, to a driving operation to be responsiveness suited to each of a shift position and a traveling mode while suppressing the vibration of the vehicle body as effectively as possible.

The present invention, according to one embodiment thereof, provides a vehicle body vibration control device for a vehicle, including: a request driving force calculation unit configured to calculate a request driving force of a driver; a driving unit configured to apply a driving force to the vehicle; a driving force control unit configured to control the driving unit based on a command driving force; and a notch filter configured to receive a signal indicating the request driving force from the request driving force calculation unit, subject the signal to filter processing, and output the signal subjected to the filter processing to the driving force control unit as a signal indicating the command driving force, the notch filter having a notch frequency set to a value for reducing a frequency component of vibration of a vehicle body, in which the driving unit includes an electric motor and a driving force transmission unit configured to transmit a driving force generated by the electric motor to driving wheels, in which the driving force transmission unit is configured to switch, through a shifting operation performed by the driver, a driving force transmission position at least between a standard driving force transmission position and a deceleration driving force transmission position for generating a deceleration action by the electric motor, and in which the vehicle body vibration control device further includes a notch filter control unit configured to variably set a notch degree of the notch filter in accordance with the driving force transmission position.

According to the above-mentioned configuration, the signal indicating the request driving force is processed by the notch filter having the notch frequency set to the value for reducing the frequency component of the vibration of the vehicle body, and the processed signal is output to the driving force control unit as the signal indicating the command driving force. The notch degree of the notch filter is variably set in accordance with the driving force transmission position.

Accordingly, a smoothing degree of the driver's request driving force during the generation of the command driving force through the filter processing can be set to be variable in accordance with the driving force transmission position. This enables changing of responsiveness of the driving force of the vehicle to a driving operation in accordance with the driving force transmission position. As a result, according to one embodiment of the present invention, as compared to where the notch degree of the notch filter is not set to be variable, the responsiveness of the driving force of the vehicle to the driving operation can be made appropriate in accordance with the driving force transmission position.

Further, according to one embodiment of the present invention, in the above-mentioned configuration, the vehicle may include a switch to be operated by the driver so as to switch a traveling mode of the vehicle. The switch may be configured to switch the traveling mode at least between a standard traveling mode for setting a response of the driving force generated by the electric motor to a driving operation of the driver to be a standard response and a low-response traveling mode for setting the response of the driving force to be a response lower than the standard response. The notch filter control unit may be configured to variably set the notch degree of the notch filter in accordance with at least one of the driving force transmission position and the traveling mode.

According to the above-mentioned configuration, the smoothing degree of the driver's request driving force during the generation of the command driving force through the filter processing can be set to be variable in accordance with the at least one of the driving force transmission position or the traveling mode. This enables changing of the responsiveness of the driving force of the vehicle to the driving operation in accordance with the driving force transmission position and/or the traveling mode. As a result, according to one embodiment of the present invention, as compared to where the notch degree of the notch filter is not variably set, the responsiveness of the driving force of the vehicle to the driving operation can be made appropriate in accordance with the driving force transmission position and/or the traveling mode.

Further, according to one embodiment of the present invention, in the above-mentioned configuration, when the driving force transmission position is the deceleration driving force transmission position, the notch filter control unit may set the notch degree to a smaller value than a value of the notch degree when the driving force transmission position is the standard driving force transmission position.

According to the above-mentioned configuration, when the driving force transmission position is the deceleration driving force transmission position, the notch degree is set to a smaller value than that when the driving force transmission position is the standard driving force transmission position. Accordingly, when the driving force transmission position is the deceleration driving force transmission position, a delay of the driving force caused by the filter processing can be reduced compared to that when the driving force transmission position is the standard driving force transmission position. As a result, the responsiveness of the driving force of the vehicle to the driving operation can be increased. In particular, when a driving operation amount is reduced to decelerate the vehicle, the engine brake can be applied with high responsiveness with respect to the reduction of the driving operation amount.

Further, according to one embodiment of the present invention, in the above-mentioned configuration, when the traveling mode is the low-response traveling mode, the notch filter control unit may set the notch degree to a larger value than a value of the notch degree when the traveling mode is the standard traveling mode.

According to the above-mentioned configuration, when the traveling mode is the low-response traveling mode, the notch degree is set to a larger value than that when the traveling mode is the standard traveling mode. Accordingly, when the traveling mode is the low-response traveling mode, the delay of the driving force caused by the filter processing can be increased to moderate the change of the driving force compared to that when the traveling mode is the standard traveling mode. As a result, the responsiveness of the driving force of the vehicle to the driving operation can be reduced.

Further, according to one embodiment of the present invention, in the above-mentioned configuration, the vehicle may be one of a hybrid vehicle, an electric vehicle, and a fuel-cell vehicle.

According to the above-mentioned configuration, in any of the hybrid vehicle, the electric vehicle, and the fuel-cell vehicle, the responsiveness of the driving force of the vehicle to the driving operation can be made appropriate in accordance with the driving force transmission position and/or the traveling mode.

### BRIEF DESCRIPTION OF THE DRAWINGS

FIG. 1 is a block diagram illustrating a vehicle body vibration control device for a vehicle according to an embodiment of the present invention, which is applied to a vehicle including a hybrid system as a driving unit.

FIG. 2 is a block diagram illustrating a notch filter control block according to the embodiment of the present invention.

FIG. 3 is a graph showing an example of frequency characteristics of a notch filter, in other words, a relationship between a frequency and a gain.

FIG. 4 is a flowchart illustrating a notch degree control routine executed in the notch filter control block of an electronic control unit according to the embodiment of the present invention.

FIG. 5 is a map for calculating a driver's request driving force based on a vehicle speed and an accelerator opening.

### DETAILED DESCRIPTION OF THE PREFERRED EMBODIMENTS

Now, exemplary embodiments of the present invention are described in detail referring to the accompanying drawings.

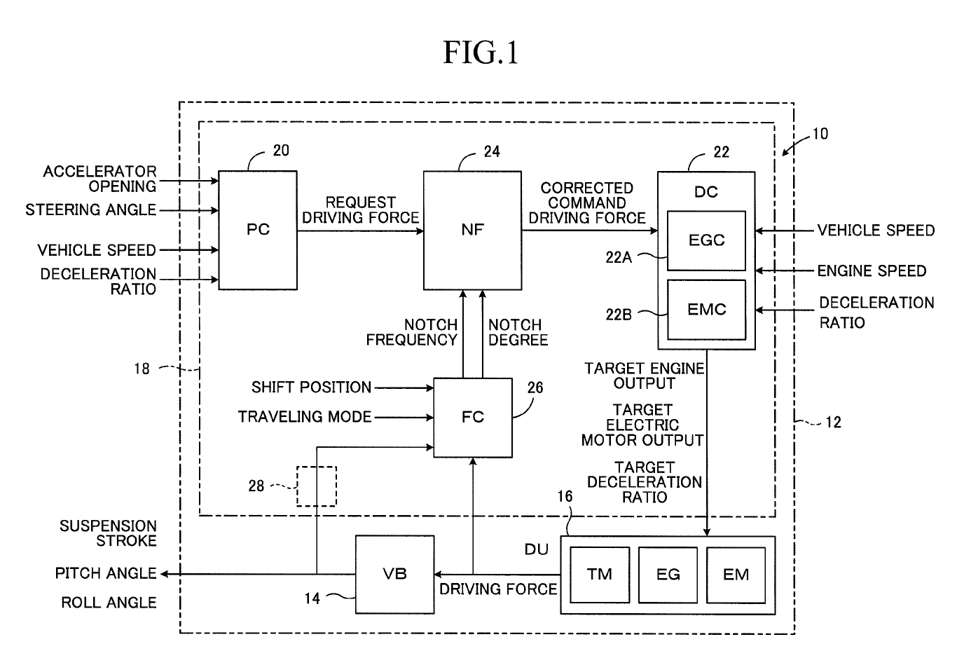

FIG. 1 is a block diagram illustrating a vehicle body vibration control device 10 for a vehicle according to an embodiment of the present invention. In FIG. 1, the vehicle body vibration control device 10 is mounted on a vehicle 12, and includes a vehicle body (VB) 14, a driving unit (DU) 16 configured to apply a driving force to the vehicle 12 including the vehicle body 14, and an electronic control unit (ECU) 18 configured to control the driving unit 16.

In the illustrated embodiment, the driving unit 16 is a hybrid system including an electric motor EM, an engine EG, and a transmission TM (for example, continuously variable transmission). However, as long as the driving unit 16 includes the electric motor, the driving unit may include only the electric motor, or include the electric motor and a fuel cell in combination. It is preferred that the electric motor be an electric motor generator that functions as a regenerative generator. The electronic control unit 18 may be an arbitrary electronic control unit having a calculation function and a storage function, for example, as in the case of a microcomputer.

The electronic control unit 18 includes a request driving force calculation block (PC) 20 configured to calculate a driver's request driving force, and a driving force control block (DC) 22 configured to output a signal for controlling a driving force to the driving unit 16. Signals indicating an accelerator opening and a steering angle, which correspond to a driver's steering operation amount, and signals indicating a vehicle speed and a deceleration ratio of the transmission, which correspond to parameters indicating a driving state of the vehicle, are input to the request driving force calculation block 20. The request driving force calculation block 20 calculates a driver's request driving force based on the accelerator opening, the steering angle, the vehicle speed, and the deceleration ratio, or another arbitrary driving force calculation input parameter in addition to those parameters.

A signal indicating the driver's request driving force is input to a notch filter (NF) 24. The notch filter 24 suppresses or blocks transmission of a notch frequency component among frequency components included in the signal indicating the request driving force to reduce the notch frequency component. In this case, the notch frequency is basically set to a resonance frequency of the vehicle body. The signal indicating the request driving force (command driving force) corrected through processing of the notch filter 24 is input to the driving force control block 22.

The driving force control block 22 includes an engine control unit (EGC) 22A and an electric motor control unit (EMC) 22B. The driving force control block 22 determines a target engine output, a target electric motor output, and a target deceleration ratio based on the parameters such as the command driving force, the vehicle speed, an engine speed, a deceleration ratio and the like, and the driving force control block 22 outputs signals indicating those target engine output, target electric motor output, and target deceleration ratio to the driving unit 16.

The engine is controlled based on the target engine output, the electric motor is controlled based on the target electric motor output, and the transmission is controlled based on the target deceleration ratio. Accordingly, the driving unit 16 applies a driving force corresponding to the command driving force to the vehicle 12 including the vehicle body 14. When the driving force is applied to the vehicle 12 and fluctuates, the vehicle body 14 of the vehicle vibrates. In particular, vibration such as pitching vibration or rolling vibration of the vehicle body appears as a change in suspension stroke, pitch angle, or roll angle.

A signal indicating the driving force applied to the vehicle 12 by the driving unit 16, and a signal indicating the change in suspension stroke, pitch angle, or roll angle, which occurs in the vehicle body 14 due to the fluctuation of the driving force, are input to a notch filter control block (FC) 26. A signal indicating a shift position selected with a shift lever (not shown) operated by a driver is also input to the notch filter control block 26. A signal indicating a traveling mode of the vehicle, which is selected by a traveling mode selection switch (not shown) operated by the driver, is also input to the notch filter control block 26.

Although not shown in FIG. 1, the transmission TM is configured to be switched, through the driver's shift lever operation, between a normal (N) range that is a standard driving force transmission position and a brake (B) range that is a deceleration driving force transmission position for generating a deceleration action by the electric motor. When the shift position is in the B range, in a situation where the driver's request driving force is reduced, the deceleration degree of the vehicle is required to be generated with higher responsiveness than that when the shift position is in the N range.

The transmission TM may be switched to a sport (S) range or a manual (M) range in addition to the N range and the B range. The S range is a range in which the engine brake is lightly applied during downhill traveling of the vehicle. The M range is a range in which the driver can change the deceleration ratio by performing a shifting operation as in the case of a manual transmission vehicle. The shift positions described above are those unique to the vehicle including the electric motor as the driving source.

The traveling mode selection switch is configured to be switched between a standard traveling (normal) mode for setting a response of a driving force generated by the electric motor to a driver's driving operation to be a standard response and an eco-traveling mode for setting the response of the driving force to be a response lower than the standard response. When the traveling mode selection switch is in the eco-traveling mode, responsiveness of the driving force generated by the electric motor to the driver's driving operation is required to be lower than that when the traveling mode selection switch is in the standard traveling mode.

The traveling mode selection switch may be switched to an electric vehicle (EV) mode or a snow mode in addition to the standard traveling mode and the eco-traveling mode. The EV mode is a mode for driving the vehicle only by the driving force of the electric motor without using any driving force of the engine. The snow mode is a mode for enabling smooth start on a slippery road surface such as a snowy road. The traveling modes described above are characteristic traveling modes of the vehicle including the electric motor as the driving source.

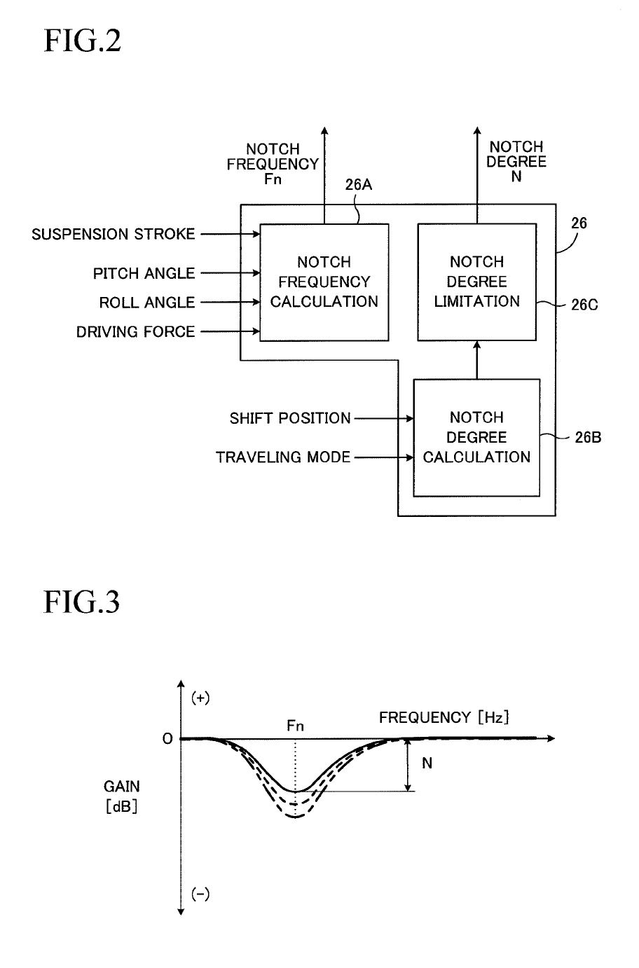

As illustrated in FIG. 2, the notch filter control block 26 includes a notch frequency calculation block 26A, a notch degree calculation block 26B, and a notch degree limitation block 26C. The notch frequency calculation block 26A variably controls a notch frequency of the notch filter 24. Specifically, the notch frequency calculation block 26A calculates an amplitude distribution of pitching vibration or rolling vibration of the vehicle body with respect to a frequency of the command driving force on the basis of the correspondence between the frequency of the command driving force and vibration of the vehicle body 14, in particular, the pitching vibration or the rolling vibration of the vehicle body. Then, the notch frequency calculation block 26A controls the notch frequency so as to minimize amplitude of the pitching vibration or the rolling vibration of the vehicle body.

For example, the notch frequency calculation block 26A performs frequency analysis by a Fourier transform method for response motion of the vehicle body to a driving force applied to the vehicle in various driving states of the vehicle. Then, the notch frequency calculation block 26A calculates an amplitude distribution of the pitching vibration or the rolling vibration of the vehicle body with respect to the frequency of the command driving force, and controls the notch frequency so as to minimize the amplitude thereof.

In this case, a signal indicating the pitching or the rolling of the vehicle body, which is input to the notch filter control block 26, may be subjected to low-pass filter processing by a low-pass filter as indicated by a broken-line block 28 of FIG. 1. Through the low-pass filter processing, vehicle body vibration of a relatively low frequency of about 1 Hz to 2 Hz, which is easily generated by resonance along with a change in driving operation amount such as the accelerator opening or the steering angle, is efficiently extracted. As a result, the notch frequency can be more accurately controlled.

The control itself of the notch frequency of the notch filter 24 is not a main subject of the present invention. Accordingly, the notch frequency may be calculated through an arbitrary procedure as long as the notch frequency is calculated to a value, for example, corresponding to a resonance frequency of the vehicle body so as to effectively reduce the pitching vibration or the rolling vibration of the vehicle body. For example, as another control procedure, a procedure described in paragraphs [0036] to [0038] of Japanese Patent Application Laid-open No. 2007-237879 filed by the applicant of this application may be used.

The notch degree calculation block 26B increasingly and decreasingly controls the notch degree of the notch filter 24, in other words, an attenuation degree of a component of the notch frequency. FIG. 3 shows frequency characteristics of the notch filter 24, in which Fn denotes a notch frequency. As can be understood from FIG. 3, a notch degree N indicates a depth of a V-shaped notch in the frequency characteristics. As the notch degree is higher, an attenuation degree of a driver's request driving force in the notch frequency is higher.

As illustrated in FIG. 2, the notch degree calculation block 26B variably sets the notch degree of the notch filter based on at least one of the shift position and the traveling mode. The notch degree calculation block 26B may variably set the notch degree also based on parameters of driving states of the vehicle or an accelerator opening. The parameters of the driving states of the vehicle may include a vehicle speed, an engine speed, a deceleration ratio and the like.

The notch degree limitation block 26C corrects the notch degree N calculated by the notch degree calculation block 26B when necessary so as to prevent the notch degree from falling out of a range between an upper limit reference value and a lower limit reference value. The notch degree limitation block 26C may be omitted.

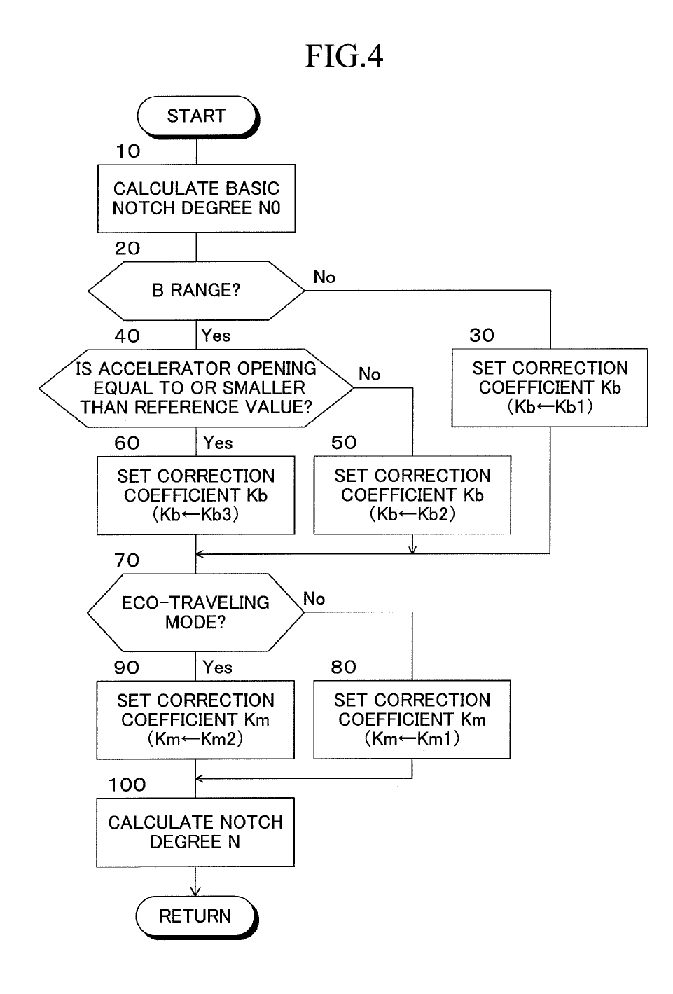

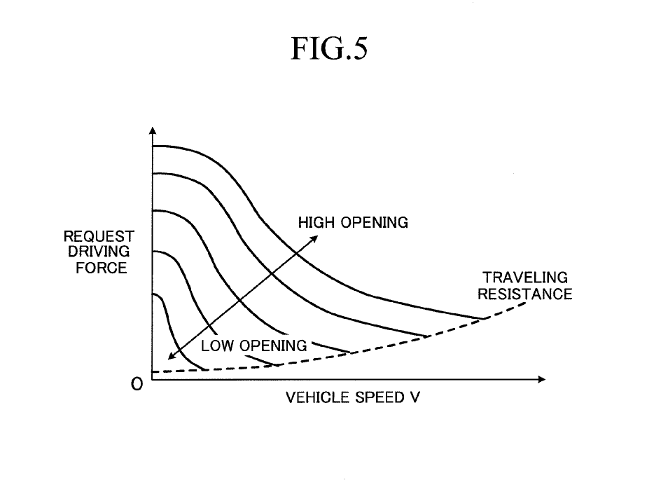

FIG. 4 is a flowchart illustrating an example of a notch degree calculation routine executed in the notch degree calculation block 26B. Control executed in accordance with the flowchart illustrated in FIG. 4 is started by turning ON an ignition switch (not shown), and is repeatedly executed at each predetermined time interval. In the description of the flowchart illustrated in FIG. 4, the control processing executed in accordance with the flowchart is simply referred to as control processing.

In Step 10, a basic notch degree N0 of the notch filter 24 is calculated based on a vehicle speed, an accelerator opening (driver's driving operation amount) and the like. Torque of the electric motor is lowered along with increase of the revolution speed, and thus the basic notch degree may be set smaller as the vehicle speed is higher. The basic notch degree N0 may be set to a preset fixed value.

In Step 20, determination is made as to whether or not the shift position is in the B range. When the determination is positive (YES), the control processing proceeds to Step 40. When the determination is negative (NO), in Step 30, a correction coefficient Kb based on the shift position for correcting the notch degree N is set to a standard correction coefficient Kb1 (1 or positive constant close to 1).

In Step 40, determination is made as to whether or not the accelerator opening is equal to or smaller than a reference value (positive constant close to 0) of accelerator opening determination, in other words, whether or not the driver desires deceleration. When the determination is negative (NO), in Step 50, the correction coefficient Kb is set to a positive value Kb2 smaller than the standard correction coefficient Kb1. On the other hand, when the determination is positive (YES), in Step 60, the correction coefficient Kb is set to a positive value Kb3 smaller than the value Kb2.

In Step 70, determination is made as to whether or not the traveling mode is the eco-traveling mode. When the determination is negative (NO), in Step 80, a correction coefficient Km based on the traveling mode is set to a standard coefficient Km1 (positive constant smaller than 1). On the other hand, when the determination is positive (YES), in Step 90, the correction coefficient Km is set to a positive value Km2 larger than the standard coefficient Km1.

In Step 100, the notch degree N of the notch filter 24 is calculated as a product of Kb×Km×N0, specifically, a product of the correction coefficient Kb based on the shift position, the correction coefficient Km based on the traveling mode, and the basic notch degree N0.

As apparent from the above description, the request driving force calculation block 20, the driving force control block 22, and the notch filter control block 26 respectively function as a request driving force calculation unit, a driving force control unit, and a notch filter control unit of the present invention. The functions of those blocks and the notch filter 24 are achieved under control of the electronic control unit 18. For example, each function is achieved by a calculation control unit such as a microcomputer constructing the electronic control unit 18 in accordance with a control program.

According to the embodiment, when the shift position is in the B range, the notch degree N of the notch filter 24 is calculated to a value smaller than that when the shift position is in the N range. Accordingly, when the shift position is in the B range, filter processing of the notch filter 24 can be performed more gently than that when the shift position is in the N range. As a result, when the shift position is in the B range, responsiveness of the driving force of the vehicle to the driver's driving operation can be set higher than that when the shift position is in the N range.

In particular, in the B range of the shift position, when the accelerator opening is equal to or less than the reference value of the accelerator opening determination and the driver desires deceleration, the notch degree N of the notch filter 24 is set to an even smaller value. Thus, for example, in a situation where the driver's request driving force is reduced, the deceleration of the vehicle can be generated with high responsiveness.

When the traveling mode is the eco-traveling mode, the notch degree N is calculated to a value larger than that when the traveling mode is the standard traveling mode. Accordingly, when the traveling mode is the eco-traveling mode, filter processing of the notch filter 24 can be performed more significantly than that when the traveling mode is the standard traveling mode. As a result, when the traveling mode is the eco-traveling mode, responsiveness of the driving force of the vehicle to the driver's driving operation can be moderate compared to that when the traveling mode is the standard traveling mode, and thus fuel efficiency can be improved by suppressing a sudden change of the driving force.

As the number of parameters for correcting the notch degree is larger, an increase/decrease range of the notch degree of the notch filter 24 may be larger with higher possibility. The notch degree is higher as the number of parameters for increasing the notch degree is larger. Conversely, the notch degree is lower as the number of parameters for decreasing the notch degree is larger. For example, in the example illustrated in FIG. 4, when negative determination is made in Step 20 and positive determination is made in Step 70, the notch degree N is set to a largest value. Conversely, when positive determination is made in Steps 20 and 40 and negative determination is made in Step 70, the notch degree N is set to a smallest value.

However, according to the embodiment, a limit imposed by the notch degree limitation block 26C enables prevention of the notch degree N from being set to an excessively large or small value. Thus, the notch degree can be increased and decreased in accordance with the shift position, the traveling mode, and the parameters of the driving state of the vehicle, and prevented from being set to an excessively large or small value.

Accordingly, excessive correction of the driving force through the notch filter 24 due to an excessively large value of the notch degree can be prevented. As a result, vibration of the vehicle body can be reduced while preventing driver's unsatisfactory feeling as to acceleration due to deteriorated acceleration performance of the vehicle. Conversely, a shortage of correction of the driving force through the notch filer 24 due to an excessively small value of the notch degree can be similarly prevented. Thus, a driver's acceleration request can be satisfied while preventing a situation from occurring where the vibration of the vehicle body cannot be reduced.

The specific embodiment of the present invention is described in detail above. However, the present invention is not limited to the above-mentioned embodiment. It is apparent for those skilled in the art that various other embodiments may be employed within the scope of the present invention.

For example, in the above-mentioned embodiment, the basic notch degree N0 is calculated based on the vehicle speed and the accelerator opening. However, the parameters for calculating the basic notch degree may be a plurality of arbitrary parameters.

In the above-mentioned embodiment, the correction coefficient Kb of the notch degree is calculated depending on whether the shift position is in the N range or the B range. However, correction may be performed in such a manner that the S and M ranges are added as shift positions in addition to the N and B ranges and the correction coefficient Kb of the notch degree is calculated depending on whether the shift position is in the N range, the B range, the S range, or the M range.

Similarly, in the above-mentioned embodiment, the correction coefficient Km of the notch degree is calculated depending on whether the traveling mode is the standard traveling mode or the eco-traveling mode. However, correction may be performed in such a manner that the EV mode and the snow mode are added as traveling modes in addition to the standard traveling mode and the eco-traveling mode and the correction coefficient Km of the notch degree is calculated depending on whether the traveling mode is the standard traveling mode, the eco-traveling mode, the EV mode, or the snow mode.

In the above-mentioned embodiment, the fluctuation range of the notch degree is limited by the notch degree limitation block 26C. However, the limit on the fluctuation range of the notch degree, in particular, the limit based on the lower limit value, may be omitted.

In the above-mentioned embodiment, the driver's request driving force is estimated based on the accelerator opening. However, correction may be performed in such a manner that the driver's request driving force is calculated from a map illustrated in FIG. 5 based on the vehicle speed and the accelerator opening. In FIG. 5, a high opening degree and a low opening respectively mean a large accelerator opening and a small accelerator opening.

Further, a vehicle to which the vehicle body vibration control device of the present invention is applied may be any of a rear-wheel-drive vehicle, a front-wheel-drive vehicle, and a four-wheel-drive vehicle.

1. A vehicle body vibration control device for a vehicle, comprising:
a request driving force calculation unit configured to calculate a request driving force of a driver;
a driving unit configured to apply a driving force to the vehicle;
a driving force control unit configured to control said driving unit based on a command driving force; and
a notch filter configured to receive a signal indicating the request driving force from said request driving force calculation unit, subject the signal to filter processing, and output the signal subjected to the filter processing to said driving force control unit as a signal indicating the command driving force, the notch filter having a notch frequency set to a value for reducing a frequency component of vibration of a vehicle body,
wherein said driving unit comprises an electric motor and a driving force transmission unit configured to transmit a driving force generated by said electric motor to driving wheels,
wherein said driving force transmission unit is configured to switch, through a shifting operation performed by the driver, a driving force transmission position at least between a standard driving force transmission position and a deceleration driving force transmission position for generating a deceleration action by said electric motor, and
wherein said vehicle body vibration control device further comprises a notch filter control unit configured to variably set a notch degree of said notch filter in accordance with said driving force transmission position.

2. A vehicle body vibration control device for a vehicle according to claim 1,
wherein the vehicle comprises a switch to be operated by the driver so as to switch a traveling mode of the vehicle,
wherein said switch is configured to switch the traveling mode at least between a standard traveling mode for setting a response of the driving force generated by said electric motor to a driving operation of the driver to be a standard response and a low-response traveling mode for setting the response of the driving force to be a response lower than the standard response, and
wherein said notch filter control unit is configured to variably set the notch degree of said notch filter in accordance with at least one of said driving force transmission position and said traveling mode.

3. A vehicle body vibration control device for a vehicle according to claim 1, wherein when said driving force transmission position is said deceleration driving force transmission position, said notch filter control unit sets the notch degree to a smaller value than a value of the notch degree when said driving force transmission position is said standard driving force transmission position.

4. A vehicle body vibration control device for a vehicle according to claim 2, wherein when said traveling mode is said low-response traveling mode, said notch filter control unit sets the notch degree to a larger value than a value of the notch degree when said traveling mode is said standard traveling mode.

5. A vehicle body vibration control device for a vehicle according to claim 1, wherein the vehicle comprises one of a hybrid vehicle, an electric vehicle, and a fuel-cell vehicle.

6. A vehicle body vibration control device for a vehicle according to claim 2, wherein the vehicle comprises one of a hybrid vehicle, an electric vehicle, and a fuel-cell vehicle.

7. A vehicle body vibration control device for a vehicle according to claim 3, herein the vehicle comprises one of a hybrid vehicle, an electric vehicle, and a fuel-cell vehicle.

8. A vehicle body vibration control device for a vehicle according to claim 4, wherein the vehicle comprises one of a hybrid vehicle, an electric vehicle, and a fuel-cell vehicle.
